(19) United States
(12) Patent Application Publication
(10) Pub. No.: US 2024/0156124 A1
(43) Pub. Date: May 16, 2024

(54) JELLY BEANS OR GUMMIES HAVING HIGH PROTEIN CONTENT AND WITH FUNCTIONAL INGREDIENTS AND MANUFACTURING METHOD

(71) Applicant: NUTRIS INGREDIENTS, S.L., Madrid (ES)

(72) Inventor: Pedro De La Fuente Blasco, Madrid (ES)

(21) Appl. No.: 18/089,787

(22) Filed: Dec. 28, 2022

(30) Foreign Application Priority Data
Nov. 15, 2022 (ES) P 202230986

(51) Int. Cl. A23G 3/44; A23G 3/34; A23G 3/42; A23G 3/48

(52) U.S. Cl. CPC A23G 3/44; A23G 3/0053; A23G 3/42; A23G 3/48

(57) ABSTRACT

The present invention relates to jelly beans wherein the amount of protein is at least 75% by weight and with a maximum amount of 18.69% carbohydrates, wherein the functional ingredients with a composition of: Proteins: 75-91.69%, Carbohydrates and/or sweeteners: 1-18.69%, Gelling agents: 1-10%, aromas: 0.01%-5%, colourings: 0.01%-5%, Functional (Food and Pharmaceutical) ingredients: 0.1-25%, Water: 5-25%, Acid: 0.1-5%, and PH correctors. The manufacturing method comprises the steps of:
Preparing a base dough by mixing proteins and sugar
Preparing an organoleptic dough
Preparing a mixture of one or several functional ingredients
Mixing of all previous doughs
Depositing
Drying
Demoulding
Packaging

Gummies are obtained having healthy functional ingredients, with a predominantly protein base of no less than 75% of the total composition and with a maximum of 18.69% carbohydrates that do not represent a significant alteration in the solubility of the dough and the pH.

### OBJECT OF THE INVENTION

The object of the present invention, as the title of the invention jelly beans or gummies establishes, also known as gummies having a high protein content in addition to functional ingredients. Also, the object of the present application is the method of manufacturing said jelly beans.

The present invention is characterised in that it has a high protein content and a maximum amount of carbohydrates of 18.69%, with functional ingredients, including food ingredients (plant extracts, powdered, liquid or semisolid plants, amino acids, proteins (collagen among others), vitamins, minerals, oils, fibres, live or stained probiotic microorganisms and/or pharmaceutical functional ingredients such as analgesic, anti-inflammatory, antiviral, anti-infective, antifungal, antipyretic ingredients and/or stem cells or derivatives.

The present invention is characterised by the particular specifications of the gummy, since the composition is predominantly based on proteins of animal, vegetable or synthetic origin such as glycine, collagen, rice protein, pea proteins, lentil proteins, hemp proteins, soy proteins, among other sources that achieve adequate gelation and stability for the consumption thereof and the steps of the method, carried out in several phases, each of these phases aims to manufacture a specific dough that will form part of a final mixture called “final dough” that will become, after drying, the gummy of this invention.

In this invention, the term gummy encompasses a pharmaceutical formulation in the form of a jelly bean that can be manufactured in numerous moulds and shapes. Therefore, the term gummy in this invention is synonymous with pharmaceutical formulation and/or soft, hard or semi-solid jelly beans.

Therefore, the present invention is circumscribed within the scope of a new gummy and the manufacture of gummy-type sweets and pharmaceutical forms, as well as, within a new food matrix with applications for health, also within a novel pharmaceutical formulation with application in the food, pharmaceutical, medical field and in general in the food and health sectors.

### BACKGROUND OF THE INVENTION

Gummies are sweet chewy candies, prepared from jellies, pectins, starches, agar-agar and other ingredients with gelling capacity to which sweeteners, food flavorings and colourings are added. They have a finish so that they do not stick together, consisting of a coating based on vegetable oils, sugar or polyols, acids or some amino acids such as glycine. They have an infinite number of shapes: bears or other animals, coca cola bottles, rings, different fruits, etc.

Jelly beans can be considered as a pharmaceutical formulation. So far no gummies with functional ingredients responsible for healthy activity are known, the main and predominant composition of which are proteins and which have a maximum of less than 25% carbohydrates.

The incorporation of the functional assets described above (including ingredients considered pharmaceutical), such as proteins in amounts greater than 75% of the total weight of the gummy represent a series of difficulties that influence the gelation and/or solidification process of this novel pharmaceutical formulation due to the following:
A modification of the usual base that makes up these products,
A variation in the behaviour of the solubility and homogenisation of the liquid or semi-solid dough of the first steps in the manufacture of the gummies,
A variation of the key parameters (pH, dry residue, Brix, solubility, temperature and moisture among others)

Indeed, the solubility of proteins in such a high percentage is not easy to achieve, especially if we limit the dissolution and homogenisation temperature to a maximum range of 80-90° C. and with a limited pH range between 2.5 and 7.5 to achieve the final gelation

Therefore, it is the object of the present invention to develop gummies with healthy functional ingredients, either food or pharmaceutical, with a predominant protein base of no less than 75% of the total composition and with a maximum of carbohydrates of less than 18.69% that do not imply a significant alteration in the solubility of the dough and the pH, or any impediment in the gelation process during the manufacturing of the gummies, developing a process such as the one described below and which is summarised in its essential nature in the first claim.

### DESCRIPTION OF THE INVENTION

The object of the present invention is collected in its essentiallity in the independent claim and the different embodiments are included in the dependent claims.

The subject matter of the present invention is a gummy with either food or pharmaceutical functional ingredients, as described in the subject matter of the invention, with a predominant composition of at least 75% protein and a maximum of 18.69% carbohydrates in any of its forms. The composition of the gummies or jelly beans or gummy-based pharmaceutical formulation included in this invention will be:
1.—Proteins: 75-91.69%
2.—Carbohydrates and/or sweeteners: 1-18.69%
3.—Gelling agents: 1-10%
4.—Aromas: 0.01%-5%.
5.—Colourings: 0.01%-5%
6.—Functional ingredients (Food and Pharmaceutical): 0.1-25%.
7.—Water: 5-25%
8.—Acid: 0.1-5%.

Wherein the percentages are percentages by weight of the final composition.

The base dough for the preparation would be, gelling agents that could be pectin, gelatin, agar-agar or starch, more protein, more sugar, glucose or fruit syrup in the case of gummies with sugar or natural and synthetic sweeteners such as (Polyols maltitol, erythritol, sorbitol, Isomalto Oligosaccharide, Allulose, Isomaltose, stevia, monk fruit, etc.), fibres (FOS, polydextrose, IMO, etc) and/or other natural or synthetic sweeteners, finally buffers for controlling acidity.

The total sum of the ingredients described must add up to 100% and no less than 75% must be proteins and also has pH correctors:

This gummy is carried out through a manufacturing method comprising the following steps:
On the one hand, firstly, the dough, “basic dough”, is prepared, that will make up the gummy by mixing proteins and sugar and/or glucose syrup and/or vegetable, animal, synthetic or fermentation fibres and/or sweeteners, water and gelatin or pectin or agar-agar or starch or collagen or carrageenan or other gelling agents. The carbohydrate sources, the maximum amount of which cannot exceed 18.69% by weight of the final product, can be sugars, fibres such as polydextrose and other vegetable fibres such as Fructologosaccharides or mixtures and/or modifications thereof. The protein sources will be mainly vegetable, but not exclusively since we have verified that both vegetable proteins (rice, lentils, peas, beans, chickpeas, sesame, among others) and animal or synthetic origin proteins (collagen, glycine, etc. . . . ) can be part of this new gummy or pharmaceutical form. These ingredients could be organic and the product could be therefore claimed as such. The exact amounts of each ingredient are not always the same, but rather, each factory plays with certain proportions that will eventually give it a texture, consistency and organoleptic properties specific to the gummy.
In this invention it is specified that the minimum amount of protein will be 75% of the final composition of the gummy, therefore, in this first phase of preparation, the initial dough must have a minimum amount of 75% protein as well as a maximum amount of 18.69% carbohydrates.
On the other hand, in a complementary manner, a mixture is additionally prepared with the aromas, flavours and other excipients which interfere with the organoleptic properties of the gummy, as well as with the pH, which is essential for the gummy to eventually gel and stay consistent. This mixture is called Organoleptic Dough.
Next, an independent mixture is made that will consist of mixing one or several functional ingredients, either food or pharmaceutical. This preparation will be made by means of a homogenisation of the ingredients that allows their incorporation into the Final Mixture described below, in a stable manner that guarantees the non-degradation thereof. This preparation is called Functional ingredients dough or Premix Dough.
Next, all previous doughs, i.e., the base dough, the organoleptic dough and the functional ingredients dough are mixed into a single dough, called “Final Mixture”. This mixing must be done at a maximum temperature of 90° C. and a moisture of less than 25% and with a maximum pH between 1-7.5 to guarantee the preservation of the functional ingredients that provide functionality to the gummy.
Depositing of this final mixture in trays with a starch base or on metal, plastic, fibreglass or silicone trays, on which the moulds of the gummies have been previously placed through a machine called a Mogul or equivalent. The moulds are the shapes, in other words, bear, fruits, pills, capsules, granules, etc. These moulds are filled with the final dough.
Drying of the filled moulds in rooms where the moisture and temperature are controlled until the gummy can be demoulded.
Demoulding of the gummy, ensuring that the maximum temperature of 90° C. is not exceeded.
Packaging of the gummies once demoulded either in bulk or in daily, weekly, monthly, bimonthly or quarterly application forms.

Lastly, the real percentage that we can manufacture is up to 99% protein. For this reason we would like to protect from 75% to 99%. If we have such a range of proteins, particularly 99% does not make the following ranges possible (water, carbohydrates, gelling agents . . . ) taking even the minimum ranges would add up to more than 100% with a protein proportion of 99%.

It is essential to highlight that the first phase of production, the so-called base Dough must be made at a maximum temperature of 90° C. and with a moisture content of no more than 25% and a pH between 1 and 7.5, in order to achieve a homogeneous mixture, preserve the organoleptic characteristics of the proteins and the correct stability of the final gummy.

The final mixture must also be carried out at a maximum temperature of 90° C. and with a moisture content of no more than 25% and a pH between 1 and 7.5, in order to achieve a homogeneous mixture, preserve the organoleptic characteristics of the proteins and the correct stability of the final gummy.

The functional ingredients that we use to incorporate into the mixtures are common ingredients, but these ingredients must meet specific pharmacotechnical characteristics and, in most cases, have not been previously incorporated into a predominantly protein-based gummy, so the end product of a high protein, low carbohydrate gummy with functional ingredients is novel.

The objective of the present invention is to achieve jelly beans or gummies that are a product with a high protein content, which is also sweet, mainly pleasant and attractive for children. On top of that, the aim is to obtain a gummy with a healthier base that provides a reduced amount of carbohydrates and that has a healthy nutritional profile above obtaining excellent organoleptic properties, although it is necessary to maintain a sufficient organoleptic level for consumption. Due to having the base dough with a high protein content, it offers stability to the ideal gummy for the incorporation of functional food or pharmaceutical ingredients.

Unless otherwise stated, all technical and scientific elements used in this specification have the meaning commonly understood by a person with ordinary skill in the art to which this invention belongs. In the practice of the present invention, similar or equivalent methods and materials to those described in the specification can be used.

Throughout the description and the claims, the word “comprises” and its variants do not intend to exclude other technical features, additives, components or steps. For those skilled in the art, other objects, advantages and features of the invention may be partially deduced from both the description and the embodiment of the invention.

### PREFERRED EMBODIMENT OF THE INVENTION

A possible embodiment of the gummy object of the invention is carried out by means of a method comprising the steps of:
1. On the one hand, firstly, the dough, “basic dough”, is prepared, that will make up the gummy by mixing proteins and sugar and/or glucose syrup and/or vegetable, animal, synthetic or fermentation fibres and/or sweeteners, water and gelatin or pectin or agar-agar or starch or collagen or carrageenan or other gelling agents. The carbohydrate sources, the maximum amount of which cannot exceed 18.69%, can be sugar or natural and synthetic sweeteners such as (Polyols, maltitol, erythritol, sorbitol, Isomalto Oligosaccharide, Allulose, Isomaltose, stevia, monk fruit, etc), fibres such as polydextrose and other vegetable fibres such as Fructologosaccharides and mixtures or modifications thereof. The protein sources will be mainly vegetable, but not exclusively since we have verified that both vegetable proteins (rice, lentils, peas, beans, chickpeas, sesame, among others) and animal or synthetic origin proteins (collagen, glycine, etc. . . . ) can be part of this new gummy or pharmaceutical form. These ingredients could be organic and the product could be therefore claimed as such. The exact amounts of each ingredient are not always the same, but rather, each factory plays with certain proportions that will eventually give it a texture, consistency and organoleptic properties specific to the gummy. In this invention it is specified that the minimum amount of protein will be 75% of the final composition of the gummy, therefore, in this first phase of preparation, the initial dough must have a minimum amount of 75% protein as well as a maximum amount of 18.69% carbohydrates.
On the other hand, in a possible embodiment, protein specifications must have a content greater than 70%, a moisture lower than 10% and a maximum particle size of 30 μm.
   1.1.—Optionally, a previous step of microencapsulations and/or emulsifiers of the proteins so that they do not provide allergens, also called instant powder generation process. Instant powder generation is a process for varying the solubility of proteins, where lecithins are used. Microencapsulation consists of putting the protein inside a granule that also improves the solubility and rheology. This process is not essential, we can use it or not, depending on whether the protein used or amino acid used is soluble or not.
   1.2.—Achieving a partial or complete solubility of all the components of the base mixture through continuous stirring, for a period between 1 minute and 25 minutes depending on the revolutions (rpm) of the mixer, which in no case will exceed 74 rpm.
2. On the other hand, in a complementary manner, a mixture is additionally prepared with the aromas, flavours and other excipients which interfere with the organoleptic properties of the gummy, as well as with the pH, which is essential for the gummy to eventually gel and stay consistent. This mixture is called Organoleptic Dough.
The organoleptic requirements required in a preferential but not limited manner would be, white or creamy colours, less than 10% fat content, soluble or partially soluble in water, as well as guaranteeing a density of the base dough between 0.5-1.9 g/ml that allows correct mixing with the doughs prepared in the following steps and their subsequent injection.
3. Next, an independent mixture is made that will consist of mixing one or several functional ingredients, either food or pharmaceutical. This preparation will be made by means of a homogenisation of the ingredients that allows their incorporation into the Final Mixture described below, in a stable manner that guarantees the non-degradation thereof. This preparation is called Functional ingredients dough or Premix Dough.
4. Next, all previous doughs, i.e., the base dough, the organoleptic dough and the functional ingredients dough are mixed into a single dough called “Final Mixture”. This mixing must be done at a maximum temperature of 90° C. and a moisture of less than 25% and with a maximum pH between 1-7.5 to guarantee the preservation of the functional ingredients that provide functionality to the gummy.
5. Depositing of this mixture in trays with a starch base or on metal, plastic, fibreglass or silicone trays, on which the moulds of the gummies have been previously placed through a machine called a Mogul or equivalent. The moulds are the shapes, in other words, bear, fruits, pills, capsules, granules, etc. These moulds are filled with the final dough.
6. Drying of the filled moulds in rooms where the moisture and temperature are controlled until the gummy can be demoulded.
7. Demoulding of the gummy, ensuring that the maximum temperature of 90° C. is not exceeded.
8. Packaging of the gummies once demoulded either in bulk or daily, weekly, monthly, bimonthly or quarterly application forms.

Both the first phase of production, the so-called “Base dough” and the “final mixture” must be carried out at a maximum temperature of 90° C. and with a moisture content not exceeding 25% and a pH between 1 and 7.5, in order to achieve a homogeneous mixture, preserve the organoleptic characteristics of the proteins and avoid the denaturation of the proteins and the correct stability of the final gummy.

As previously explained, it is the object of the invention, in addition to the specific manufacturing process described, a gummy having functional ingredients comprising:
1.—Proteins: 75-91.69%
2.—Carbohydrates and/or sweeteners: 1-18.69%
3.—Gelling agents: 1-10%
4.—Aromas: 0.01%-5%.
5.—Colourings: 0.01%-5%
6.—Functional ingredients (Food and Pharmaceutical): 0.1-25%.
7.—Water: 5-25%
8.—Acid: 0.1-5%.

Wherein the total sum of the ingredients described must add up to 100% and no less than 75% must be proteins and it has pH correctors. Wherein the percentages are percentages by weight of the final composition.

Among the embodiments that can be achieved are: a protein-rich gummy having multivitamins, as a pharmaceutical source of vitamins, a protein-rich gummy with melatonin to aid sleep or a protein-rich gummy with a pharmaceutical ingredient such as ibuprofen, paracetamol or antibiotic to carry out a treatment under the supervision of health professionals.

Having sufficiently described the nature of the present invention, as well as the way to put it into practice, it is noted that, within its essential nature, it may be put into practice in other embodiments that differ in detail from that indicated by way of example, and for which the protection sought will also be achieved, as long as it does not alter, change or modify its fundamental principle.

1. A gummy having proteins and functional ingredients the amount of protein is at least 75% by weight of the final composition and with a maximum amount of 18.69% carbohydrates, wherein the functional ingredients are either food or pharmaceutical ingredients, wherein the composition of this gummy will be as described below:
1.—Proteins;
2.—Carbohydrates and/or sweeteners: 1-18.69%;
3.—Gelling agents: 1-10%;
4.—Aromas: 0.01%-5%;
5.—Colourings: 0.01%-5%;
6.—Functional ingredients (Food and Pharmaceutical): 0.1-25%;
7.—Water: 5-25% and
8.—Acid: 0.1-5%
wherein the sum total of the ingredients described must add up to 100% and not less than 75% must be protein, it also has pH correctors, wherein the % expressed is the weight of the final composition.

2. A method of manufacturing gummies having proteins and functional ingredients according to claim 1, comprising the steps of:
preparation of a base dough by mixing proteins and sugar and/or glucose syrup and/or vegetable, animal, synthetic or fermentation fibres and/or sweeteners, water and gelatin or pectin or agar-agar or starch or collagen or carrageenan or other gelling agents, wherein the amount of protein in the gummies is at least 75% by weight of the gummy and wherein carbohydrate sources such as sugar and/or glucose syrup and/or vegetable, animal, synthetic or fermentation fibres and/or natural or synthetic sweeteners such as (polyols maltitol, erythritol, sorbitol, Isomalto Oligosaccharide, Allulose, Isomaltose, stevia, monk fruit, etc.), the maximum amount cannot exceed 18.69%;
preparation of a mixture with aromas, flavours and other excipients which interfere with the organoleptic properties of the gummy, as well as with the pH, which is essential for the gummy to eventually gel and stay consistent, wherein this mixture is called organoleptic dough;
preparation of a mixture of one or several functional ingredients, either food or pharmaceutical, which is called the functional ingredients dough and is made by means of the homogenisation of the ingredients that allows their incorporation into a final mixture, in a stable manner that guarantees the non-degradation thereof;
mixing of all the previous doughs, i.e., the base dough, the organoleptic dough and the functional ingredients dough are mixed into a single dough called the final mixture;
depositing of the final mixture in trays with a starch base or on metal, plastic, fibreglass or silicone trays, on which the moulds have been previously placed;
drying of the filled moulds in rooms where the moisture and temperature are controlled until the gummy can be demoulded;
demoulding of the gummy, ensuring that the maximum temperature of 90° C. is not exceeded;
packaging of the gummies once demoulded either in bulk or in daily, weekly, monthly, bimonthly or quarterly application forms;
wherein both the base dough and the final mixture must be carried out at a maximum temperature of 90° C. and with a moisture content of no more than 25% and a pH between 1 and 7.5.

3. The manufacturing method according to claim 1, wherein the carbohydrate sources are sugars, fibres such as polydextrose and other vegetable fibres such as Fructologosaccharides and mixtures or modifications thereof, while the protein sources are vegetable, and/or vegetable proteins (rice, lentils, peas, beans, chickpeas, sesame, among others) and animal or synthetic origin proteins (collagen, glycine, etc.).

4. The manufacturing method according to claim 2, wherein the proteins must have a content greater than 70%, a moisture lower than 10% and a maximum particle size of 30 μm.

5. The manufacturing method according to claim 2, wherein the proteins, prior to forming the base dough, have been subjected to a step of microencapsulations and/or emulsifiers of the proteins so that they do not provide allergens, wherein the protein is packed into a granule which improves solubility and rheology.

6. The manufacturing method according to claim 2, wherein the base mixture is subjected to a continuous stirring process, for a period between 1 minute and 25 minutes depending on the revolutions (rpm) of the mixer, which in no case will exceed 74 rpm.

7. The manufacturing method according to claim 2 wherein the organoleptic dough has, white or creamy colours, less than 10% fat content, is soluble or partially soluble in water, as well as guaranteeing a density of the base dough between 0.5-1.9 g/ml that allows correct mixing with the doughs prepared in the following steps and their subsequent injection.
